(19) United States
(12) Patent Application Publication
(10) Pub. No.: US 2004/0005461 A1
(43) Pub. Date: Jan. 8, 2004

(54) Carbonized wood-based materials

(76) Inventors: Dennis C. Nagle, Ellicott City, MD (US); Andrew Keith Kercher, Oak Ridge, TN (US)

Correspondence Address: Alan G. Towner, Pietragallo, Bosick & Gordon, One Oxford Centre, 38th Floor, 301 Grant Street, Pittsburgh, PA, 15219, US

(21) Appl. No.: 10/421,185

(22) Filed: Apr. 23, 2003

Related U.S. Application Data
(63) Continuation-in-part of application No. 09/544,063, filed on Apr. 6, 2000.
Application No. 09/544,063 is a division of application No. 08/678,084, filed on Jul. 11, 1996, now Pat. No. 6,051,096.
(60) Provisional application No. 60/374,739, filed on Apr. 23, 2002.

(51) Int. Cl. B32B 9/00

(52) U.S. Cl. 428/408; 428/541; 264/29.4

(57) ABSTRACT

A method of carbonizing fabricated wood-based materials, such as wood composition board, is disclosed. Fabricated wood-based material is used as a precursor material, which is carbonized under controlled temperature and atmosphere conditions to produce a porous carbon product having substantially the same cellular structure as the precursor fabricated wood-based material. The porous carbonized product may be used for various applications such as filters, fuel cell gas separators, and battery electrodes, or may be further processed to form carbon-polymer or carbon-carbon composites. The carbonized product may also be converted to a ceramic such as silicon carbide. Additional processing may be used to form ceramic-metal or ceramic-ceramic composites.

### CROSS-REFERENCE TO RELATED APPLICATIONS

This application is a continuation-in-part of U.S. patent application Ser. No. 09/544,063 filed Apr. 6, 2000, which is a divisional of U.S. patent application Ser. No. 08/678,084, now U.S. Pat. No. 6,051,096, which are incorporated herein by reference. This application also claims the benefit of U.S. Provisional Application Serial No. 60/374,739, filed Apr. 23, 2002, which is incorporated herein by reference.

### FIELD OF THE INVENTION

The present invention relates to carbonized wood-based materials, and more particularly relates to the production of carbonized articles from fabricated wood-based materials.

### BACKGROUND INFORMATION

Many different types of carbon-containing materials are known, and the carbonization of wood to form products such as charcoal has been practiced for thousands of years. Carbonized wood-based materials, composite materials and ceramics formed from carbonized wood are disclosed in U.S. Pat. Nos. 6,051,096 and 6,124,028, which are incorporated herein by reference.

### SUMMARY OF THE INVENTION

The process of the present invention involves treating fabricated wood-based materials under controlled atmosphere and temperature conditions to yield a porous material containing carbon. The carbonization process retains the anatomical features of the fabricated wood-based material while converting the composition of the material to primarily carbon. The carbonized material may then be formed to the desired shape for various uses. In many applications, the material will contain nearly all carbon, but may contain other elements as well. The shaped carbon product may also be used to form composites such as carbon-carbon and carbon-polymer composites. The shaped carbon product may alternatively be converted to ceramic compositions, or further processed to form ceramic-containing composites such as ceramic-metal and ceramic-ceramic composites.

In one embodiment, the carbonized material may be further converted to form other materials. For example, the carbonized material may be activated to form active carbon. As another example, the porous carbon material may be impregnated with a polymer to form a carbon-polymer composite. A high char yielding polymer may be used with a second carbonization step to yield a carbon-carbon composite. Infiltration and reaction with molten metals can produce a net shaped carbide ceramic. Additional processing may be used to produce ceramic-ceramic or ceramic reinforced metal composites. As another example, the carbonized material may be infiltrated and reacted with metal oxides to convert the carbon to ceramic.

An aspect of the present invention is to provide a method of carbonizing a fabricated wood-based material while retaining its anatomical features. The method involves the treatment of fabricated wood-based material under controlled conditions to convert the composition of the material to carbon while maintaining the cellular structure of the fabricated wood-based material.

A further aspect of the present invention is to provide a method of making a carbon-containing article. The method includes: providing a fabricated wood-based material comprising a cellular structure; heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; and recovering the carbonized material.

Another aspect of the present invention is to provide a carbonized article consisting essentially of carbon having a porous cellular structure corresponding to the cellular structure of fabricated wood-based material.

A further aspect of the present invention is to provide a method of making a carbon-polymer composite. The method includes: providing a fabricated wood-based material comprising a cellular structure; heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; cooling the carbonized material; and at least partially filling pores of the carbonized material with a polymer.

Another aspect of the present invention is to provide a method of making a carbon-metal composite. The method includes: providing a fabricated wood-based material comprising a cellular structure; heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; and at least partially filling pores of the carbonized material with metal.

A further aspect of the present invention is to provide a method of making a carbon-carbon composite. The method includes: providing a fabricated wood-based material comprising a cellular structure; heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; cooling the carbonized material; at least partially infiltrating pores of the carbonized material with a carbon-forming material; and converting at least part of the carbon-forming material to carbon.

Another aspect of the present invention is to provide a method of forming a ceramic-containing material. The method includes: providing a fabricated wood-based material comprising a cellular structure; heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; cooling the carbonized material; and converting at least part of the carbonized material to a ceramic.

Another aspect of the present invention is to provide a method of forming a ceramic-containing material. The method includes: providing a fabricated wood-based material comprising a cellular structure; heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; cooling the carbonized material; and converting at least part of the carbonized material to a ceramic.

Another aspect of the present invention is to provide a carbon-polymer composite article comprising a carbonized fabricated wood-based material comprising a porous cellular structure, and a polymer at least partially filling the pores of the carbonized fabricated wood-based material.

Another aspect of the present invention is to provide a carbon-carbon composite article comprising a carbonized fabricated wood-based material comprising a porous cellular structure, and carbon at least partially filling the pores of the carbonized fabricated wood-based material.

Another aspect of the present invention is to provide a carbon-metal composite article comprising a carbonized fabricated wood-based material comprising a porous cellular structure, and a metal at least partially filling the pores of the carbonized fabricated wood-based material.

Another aspect of the present invention is to provide a porous ceramic-containing material comprising ceramic having a porous cellular structure corresponding to a cellular structure of fabricated wood-based material.

Another aspect of the present invention is to provide a ceramic-metal composite article comprising a ceramic having a porous cellular structure corresponding to the cellular structure of fabricated wood-based material, and metal at least partially filling the pores of the ceramic.

Another aspect of the present invention is to provide a ceramic-ceramic composite article comprising a first ceramic having a porous cellular structure corresponding to the cellular structure of fabricated wood-based material, and a second ceramic at least partially filling the pores of the first ceramic.

These and other aspects of the present invention will become apparent from the following detailed description.

### BRIEF DESCRIPTION OF THE DRAWINGS

FIG. 1 is a schematic diagram illustrating various aspects of the present invention.

FIG. 2 illustrates densities of different types of fiberboard compared to densities of assorted woods.

FIG. 3 is a photograph showing a sheet of carbonized medium density fiberboard (c-MDF) next to an uncarbonized MDF material.

FIG. 4 is a photograph showing the macrostructural differences between three varieties of carbonized MDF.

FIG. 5 is a photograph of machined carbonized MDF.

FIG. 6 is a graph of percentage weight loss versus dwell time for thermogravimetric analysis (TGA) modeling of CO₂ activation of different varieties of c-MDF.

FIG. 7 is a photograph showing macrocracks formed during activation of c-MDF.

FIG. 8 is a graph of log differential volume versus pore diameter for carbonized materials.

FIG. 9 is a graph of differential volume versus pore diameter for carbonized materials.

FIG. 10 is a graph of Hg surface area versus pore diameter, showing cumulative pore surface area of macroporosity and mesoporosity.

FIG. 11 is a graph showing Brunauer-Emmett-Teller (BET) surface area of small c-MDF specimens at various activation conditions.

FIG. 12 is a graph of BET surface area versus percentage weight loss during activation.

FIG. 13 is a graph of BET surface area of through-thickness regions of large c-MDF specimens at various activation conditions.

FIG. 14 is a graph of BET surface area of in-plane regions of large c-MDF specimens at various activation conditions.

FIG. 15 is a graph of BET surface area of in-plane regions of large c-MDF specimens under various activation methods.

FIG. 16 is a graph of percentage dimensional shrinkage of c-MDF versus carbonization temperature.

FIG. 17 is a graph of c-MDF density versus carbonization temperature, showing bulk density of various c-MDF's.

FIG. 18 is a graph of c-MDF density versus primary pyrolysis ramp rate.

FIG. 19 is a graph of resistivity versus primary carbonization ramp rate.

FIG. 20 is a graph of measured resistivity versus maximum carbonization temperature.

FIG. 21 is a graph of hard carbon resistivity versus carbonization temperature.

FIG. 22 is a graph of peak stress from 4-point bending tests of c-MDF versus maximum temperature (normal orientation).

FIG. 23 is a graph of peak stress from 4-point loading tests of c-MDF versus maximum temperature (rotated orientation).

FIG. 24 is a graph of 4-point bending elastic modulus versus maximum temperature (normal orientation).

FIG. 25 is a graph of 4-point bending elastic modulus versus maximum temperature (rotated orientation).

FIG. 26 is a graph of peak stress from 4-point bending tests of c-MDF hardwood versus maximum temperature.

FIG. 27 is a graph of 4-point bending elastic modulus of c-MDF hardwood versus maximum temperature.

FIG. 28 is a graph of peak stress from 4-point bending tests versus primary pyrolysis ramp rate (normal orientation).

FIG. 29 is a graph of 4-point bending elastic modulus versus primary pyrolysis ramp rate (normal orientation).

FIG. 30 is a graph of bending modulus of large c-MDF materials versus activation time.

FIG. 31 is a graph of estimated Young's modulus of hard carbon phase in c-MDF materials versus activation time.

FIG. 32 is a graph depicting the full-width half-maximum (FWHM) difference between c-MDF at 1400° C. and other c-MDF's.

FIG. 33 is a graph depicting FWHM data of the {002} powder XRD peaks and the associated average L_{c} values for various c-MDF's.

FIG. 34 is a graph depicting powder XRD patterns of {100} peak, normalized at 2θ=60°.

FIG. 35 is a graph depicting FWHM data of the {100} powder XRD peaks and the associated average Lₐ values for various c-MDF's.

FIG. 36 is a graph depicting raw monolithic XRD patterns.

FIG. 37 is a photograph of activated charcoal cloths.

FIG. 38 is a photograph of carbonized fabric including a piece of fabric that has been converted to ceramic after carbonization in accordance with an embodiment of the present invention.

FIG. 39 is a photograph of carbonized wood samples derived from pressed wood including a sample that has been converted to ceramic after the carbonization step.

### DETAILED DESCRIPTION OF THE PREFERRED EMBODIMENTS

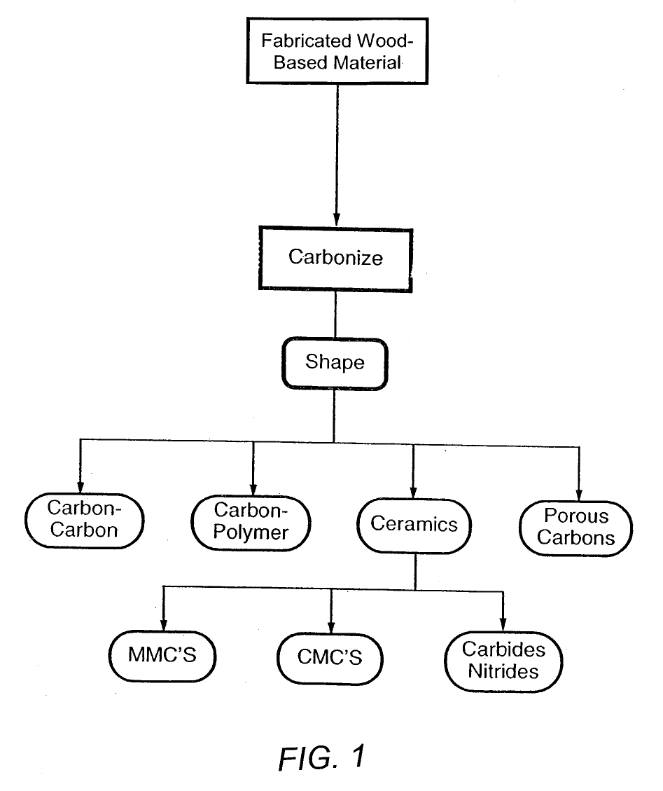

FIG. 1 schematically illustrates various aspects of the present invention. Fabricated wood-based material is carbonized under controlled conditions, with the carbonized product retaining substantially the same macrostructure as the precursor fabricated wood-based material. The carbonized material may then be formed to the desired shape by conventional working or cutting methods such as sawing, sanding, drilling, turning, milling, routing and the like. The shaped porous carbon material may be used for various applications such as shaped activated carbon, refractory insulation and high temperature filters. Alternatively, the shaped carbon material may be further processed to form carbon-containing composites including carbon-carbon and carbon-polymer composites. Such composite materials may be used for applications such as lightweight structures, furniture, brake shoes, sports equipment, high temperature tubing, brake rotors and the like.

In another embodiment, the shaped carbon material may be at least partially converted to a ceramic such as carbide or nitride. These ceramic-containing materials substantially retain the porous cellular structure of the carbonized product. Such porous ceramic materials may be used for refractory insulation, abrasives, high temperature filters, etc.

In a further embodiment, the porous ceramic structure may be infiltrated with various materials including metals and ceramics to provide composite materials for applications such as lightweight structures, cutting tools, armour, propellers, turbine blades and the like.

The present invention involves the carbonization of fabricated wood-based materials. As used herein, the term “fabricated wood-based material” means a material comprising wood or other similar cellular plant matter that has undergone fabrication processes such as consolidation of wood components or other cellular plant material by pressing, weaving or the like. The wood components may be in any suitable starting form, such as sawdust, chips, fibers, shavings, trimmings, pulp, residues and the like. Binders and other additives may optionally be used to consolidate the wood components.

In accordance with the present invention, “carbonized wood-based material,” “carbonized material,” and “carbonized product” refer to a predominantly carbon-containing material formed from the fabricated wood-based material. The carbonized material comprises at least 70 weight % carbon, preferably at least 80 weight % carbon. More preferably, the carbonized material comprises greater than about 90 weight % carbon, most preferably greater than about 95 weight % carbon. Where the carbon is provided in the form of graphite, the carbonized material typically comprises at least about 95 or 99 weight % carbon.

The carbonization process of the present invention decomposes organic constituents of the fabricated wood-based material to obtain carbon residue. Preferably, at least about 80% of the organic constituents comprising C—H bonds are decomposed to carbon, more preferably at least 90 weight %. Most preferably, at least about 95 weight % of the organic constituents are decomposed to carbon, with 99 weight % being particularly preferred. In accordance with the present invention, “graphitization” means the conversion of carbon from a substantially amorphous structure to a substantially crystalline structure, as identified by the occurrence of the {002} x-ray diffraction peak.

In one embodiment, the fabricated wood-based material includes commercially available and specially made wood composition boards such as plywood, particleboard and fiberboard. These wood composition boards are synthetic materials that contain wood components, typically held together by a binder. The wood components in plywood are veneer sheets of wood. Particleboard contains wood components typically sized much larger than wood cells. Fiberboard contains wood components with dimensions on the order of magnitude of a wood cell. The wood components may be waste products from milling operations such as planer shavings, sawdust, plywood trimmings or log residues, e.g., branches, tops and broken logs. Thermoset adhesive binders such as urea-formaldehyde or phenol-formaldhyde are typically used to bond the wood components together during a hot pressing operation.

Various classifications of particleboard exist which are differentiated by the different wood particles used, such as particleboard, flakeboard, waferboard and oriented strand board (OSB). To obtain good mechanical properties, the wood components are often long along the fiber direction and are relatively thin perpendicular to the fiber direction.

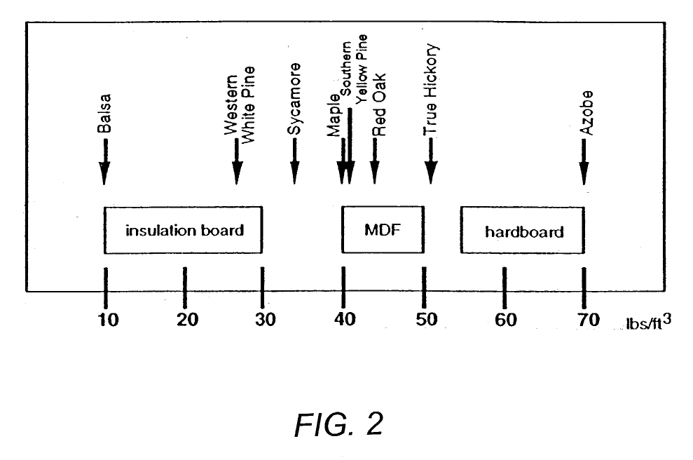

Fiberboard may be separated into three types according to density: insulationboard (about 10 to about 30 lbs/ft³), medium density fiberboard (about 40 to about 50 lbs/ft³), and hardboard (about 55 to about 70 lbs/ft³). FIG. 2 illustrates the densities of the three fiberboard classifications compared to approximate densities of assorted woods at 12% moisture content.

Despite density differences, manufacturing processes for different types of fiberboards may be similar. First, wood chips are pulped to form wood fibers. Next, the wood fibers are combined with any binders or other additives. Finally, the wood fiber mixture is formed into a mat and pressed into sheets at elevated temperature. Medium density fiberboard (MDF) and hardboard can be made by a dry process (air-laid mat), or a wet process (water medium used in making mat). Insulationboard is typically made by a wet process.

Wood fibers produced by pulping are typically wood elements with sizes on the order of wood cells. The wood fibers of fiberboard may be a combination of wood cell fragments, wood cells and wood cell bundles. The specific pulping process controls the morphology of the wood fibers. Common pulping processes include dry attrition milling, Masonite pulping (explosive steam gun), disk refining of water-soaked wood chips, and disk refining of steam-cooked wood chips. While most fiberboard is made from wood pulp, other lignocellulosic fiber sources can be used and are considered wood-based materials in accordance with the present invention. For example, Bagasse or sugarcane residue is used commercially to manufacture some insulationboard.

Fiberboard may include additives which can serve several purposes, such as sizing, fiber binding enhancement, preservation and fire protection. Sizing is the process of adding chemicals to control liquid penetration into the final fiber-based product. Common sizing materials include rosin, wax and asphalt. In some wet processes, the lignin of the wood fibers can act as a binder. The removal of water during hot processing can cause strong capillary forces that draw fibers close enough for the lignin from each fiber to strongly bond the fiberboard together. For many wet processes and dry processes, the fibers must be bonded together with a binding additive, such as phenol-formaldehyde resin, urea-formaldehyde resin and natural oils. The additives used for preservation and fire protection for fiberboard are essentially the same as those used for normal wood lumber, e.g., pentachlorophenol and aluminum trihydrate.

Hot pressing of the wood fiber mixture is needed to densify the loose fibers into a fiberboard product. The elevated temperature serves to drive off any water and cure or soften binders. In most wet processes, hot pressing of wet fiber mats requires use of a screen as one platen to allow the steam to escape. The screen platen may cause one side to be relatively rough. Fiberboards with only one side smooth are commonly referred to as S1S board. Most dry processes (and some wet processes with a pre-drying step) do not require a screen platen for steam escape and are capable of producing S2S boards.

Fiberboard mechanical properties primarily depend on the bond strength between fibers, rather than the individual fiber strengths. In MDF and insulationboard, the limited bond area between fibers may result in bond failure at stresses far below the fiber strength. In hardboard, mechanical failure often occurs in the fiber due to increased bond area (intimate fiber contact caused by high pressures during processing) and degraded fiber strength (due to severe pressing conditions). In general, fiber properties that promote large interfiber bond areas result in stronger fiberboard products. Longer fibers have more bond area with other fibers. Thus, fiberboard strength often increases with fiber length. Thin cell walled fibers can collapse under pressure, resulting in more intimate contact between fibers. Thus, thinner cell walls in the fiber precursor often result in increased fiberboard strength.

Fiber length can influence the orientation of fibers in the fiberboard. Long fibers tend to align themselves in the plane of the fiberboard sheet. Long fibers can even be preferentially aligned in one direction by mechanical or electrical methods. Short fibers may also tend to align themselves in the plane of the fiberboard sheet, but the average out-of-plane component of short fiber orientation is greater.

Fabricated wood-based materials may have several advantages over natural woods as precursors for carbonization. The structure of wood varies according to nature's variables: weather experienced by the tree or other plant, knots, grain pattern, etc. Because wood composition boards are processed to hold wood components together with an adhesive bond, the boards are less affected by natural variations. In addition, the dimensions of a natural wood product are limited by tree or plant size. Commercial wood composition boards are available in large sheets, and specially made wood-based products can potentially be pressed or machined into three-dimensional geometric shapes. Because of its uniform structure, wood composition board is less prone to cracking during carbonization than wood. The isotropic structure and properties of wood composition board may result in more rapid carbonization compared to natural wood, and more uniform dimensional shrinking compared to the dimensional shrinking of natural wood, which is highly anisotropic.

In accordance with the present invention, monolithic carbonized material can be produced without forming cracks usually associated with activated charcoal. As described more fully below, controlled atmosphere and heating rates produce thermal decomposition which avoids crack formation. Substantially all of the anatomical features of the fabricated wood-based material are retained in the carbonized material. The resulting solid carbons are easily machined to exact dimensions using standard tools and procedures.

The advantages of using carbonized wood-based material as a precursor for composites are realized when its directional morphology and properties are utilized. Carbonized wood-based material offers a monolithic porous structure for infiltration of a second phase. This structure does not necessitate the use of molding for polymer or metal transfer and eliminates the problems associated with fiber swimming. The highly aligned cells offer anisotropy of mechanical properties and permeability. The natural porosity of the carbonized material can be used to obtain uniform infiltration of a polymer. The porosity of the carbonized material can also be utilized for a solid carbon filter, adsorbent or catalysis substrate. Furthermore, net-shape processing can be obtained by shaping the carbonized material to exact dimensions before converting to a composite.

In accordance with one embodiment, materials processing using carbonized wood-based material produces industrially important ceramics such as SiC, Si₃N₄, B₄C, AlN and the like. This method allows the production of advanced ceramics of net shape. The process utilizes inexpensive precursors, eliminates the need for special handling and sintering of powders and minimizes the machining of a hard ceramic by allowing a carbonized solid material to be shaped prior to conversion to the ceramic. A ceramic which retains the cellular features of the precursor wood-based material may be produced. For example, a SiC micro-honeycomb ceramic may be produced which has potential applications for high temperature filters or as a catalyst support. Silicon carbide ceramics may also be produced which contain residual Si infiltrant. The resulting composite may optionally be nitrided to form a ceramic/ceramic composite.

In accordance with the method of the present invention, the fabricated wood-based material may be cut to any desired shape, allowing for shrinkage during the carbonization process. For example, the fabricated wood-based material may be cut into pieces having lengths of greater than about 1 inch. Such pieces may have widths of at least about 0.5 inch, and may have heights of at least about 0.1, 0.25, 0.5 inch or greater. The fabricated wood-based material may also be pressed or machined into three-dimensional shapes. The precursor pieces of wood-based material used in accordance with the present invention may have any suitable maximum size or shape depending on the desired end use. Thus, relatively large blocks, sheets, strips, rods and other shapes may be carbonized according to the present method.

In one embodiment, paper and fabrics of natural fibers offer design flexibility when producing materials using the method of carbonization of the present invention. Both woven and non-woven fabrics may be used as fabricated wood-based materials. Carbonized lignocellulosics retain the anatomical features of the precursors. In addition to the retention of features, carbonization of fabrics and papers allow for complex shapes to be produced with some preferred orientation of the natural fibers.

After the appropriate size and shape has been selected, the fabricated wood-based material is preferably heated in an inert atmosphere to achieve carbonization. The inert atmosphere is preferably non-oxidizing, e.g., containing less than 5 volume % O₂ gas, preferably less than 1 volume % and more preferably less than 1000 ppm O₂ gas. Suitable non-oxidizing atmospheres include vacuums, inert gases and noble gases. Nitrogen is a particularly preferred non-oxidizing medium. The fabricated wood-based material may be heated at subatmospheric, atmospheric and superatmospheric pressures, and combinations thereof. The use of substantially atmospheric pressure is suitable for many operations.

The fabricated wood-based material is heated in the substantially non-oxidizing atmosphere to a sufficient temperature at a sufficiently slow heat-up rate to carbonize the material while substantially maintaining the cellular structure of the precursor material. The fabricated wood-based material is preferably heated to a temperature of at least about 300° C. up to a temperature of about 1500° C. or higher. Where graphitization is desired, temperatures of at least about 2000° C. may be used. However, in one embodiment, graphitization catalysts may be used to reduce the temperature required for graphitization to less than about 2000° C. as more fully described below. Heating to a temperature of from about 400 to about 1000° C. is particularly suitable for achieving carbonization of most fabricated wood-based materials. Maximum temperatures of from about 500 to about 700° C. typically achieve the desired degree of carbonization without the necessity of reaching extremely high temperatures.

During the heating process, sufficiently slow heat-up rates are used to avoid macro cracking of the fabricated wood-based material and to maintain its cellular structure. Heat-up rates of less than about 100° C./hour may be preferred, for example, from about 1 to about 50° C./hour. In accordance with the present invention, a sufficiently slow heat-up rate between certain temperatures, such as between 200 and 400° C., has been found to be satisfactory.

The carbonized wood-based material may be at least partially converted to graphite by heating to high temperatures of at least about 2000° C., typically 2500° C. Alternatively, in accordance with an embodiment of the present invention, the precursor wood-based material may incorporate a graphitization catalyst which facilities conversion of the carbonized material to graphite at lower temperatures, e.g., less than about 2000° C. Preferred graphitization catalysts comprise elements such as Cr, Cu, Ni, B, Ti, Zr and Fe. For example, the fabricated wood-based material may be treated with a wood preservative comprising at least one of these elements which acts as a graphitization catalyst. A suitable wood preservative comprises copper chrome arsenate which, when impregnated into the wood-based material prior to the present heat treatment process, reduces the temperature required for graphitization.

Various cooling rates may be used in accordance with the present invention to reduce the temperature of the carbonized material. Cooling rates of less than about 100° C./hour may be used. However, for some applications such as activated carbon, cooling rates of greater than about 100° C./hour may be utilized.

After the carbonized material has been cooled, it may be shaped by conventional wood-working techniques. For example, the carbonized material may be cut by processes such as sawing, drilling, routing, milling, turning, grinding, sanding and the like.

In one aspect of the present invention, the pores of the carbonized material may be at least partially filled with materials such as metals, polymers, carbon and ceramics. Suitable metals include magnesium and other metals which do not adversely react with the carbon cellular structure. Suitable polymers include thermosetting resins and thermoplastic resins such as phenolformaldehyde, polyetheretherketone (PEEK), polytetrafluoroethylene, polymethylmethacrylate (PMMA), and the like. Epoxies, phenolics and pitch are particularly suitable polymers for at least partially filling the voids of the carbonized material. Where the polymer is subsequently converted to carbon to form a carbon-carbon composite, phenolic resin polymers may be preferred.

In an alternative embodiment, the carbonized wood-based material may be at least partially converted to a ceramic such as silicon carbide. The ceramic substantially retains the cellular structure of the precursor wood, including its porous structure. The pores of the ceramic material may optionally be at least partially filled with a metal. Alternatively, the pores of the ceramic may be at least partially filled with a ceramic material. For example, the pores of a silicon carbide material may be filled with residual silicon, which is converted to silicon nitride by reaction with nitrogen.

### EXAMPLE 1

In this example, MDF was carbonized to produce structural sheets. The carbonized sheets were then converted to activated carbon.

Three different varieties of ¾ inch thick MDF from Temple-Inland Corporation were provided for carbonization: southern yellow pine (MDF-SYP); northern pine (MDF-NP); and hardwood (MDF-H). Each variety of MDF was generated from different wood fiber precursor as shown in Table 1.

TABLE 1
MDF Fabricated Wood-Based Materials

| | | |
|---|---|---|
| | | Temple-Inland |
| Abbreviation | Wood Fiber Source | Trade Name |

| | | | |
|---|---|---|---|
| Southern Yellow | MDF-SYP | southern yellow | Solidium ™ |
| Pine | | pines | |
| Northern Pine | MDF-NP | white pine, red pine, | Northern Pine ™ |
| | | jack pine, etc. | |
| Hardwoods | MDF-H | red oak, white oak, | Northern Gold ™ |
| | | etc. | |

Carbonization was performed in an inconel-lined retort furnace under a gas flow of nitrogen (0.4 L/min). MDF specimens were stacked in the furnace with graphite sheets between them to obtain a uniform specimen temperature. The basic thermal schedule was:

50° C./hr to 110° C.

3 hr dwell

15° C./hr to 200° C.

30° C./hr to 400° C. (primary pyrolysis)

15° C./hr to 600° C.

50° C./hr to maximum temperature (e.g., 1000° C.)

The primary pyrolysis ramp rate was varied and the maximum carbonization temperature was fixed at 1000° C. To obtain 1400° C. and 1500° C. MDF samples (c-MDF 1400° C., c-MDF 1500° C.), MDF carbonized to 1000° C. was heated in a tube furnace at 4° C./min in argon (flow rate of 0.25 L/min).

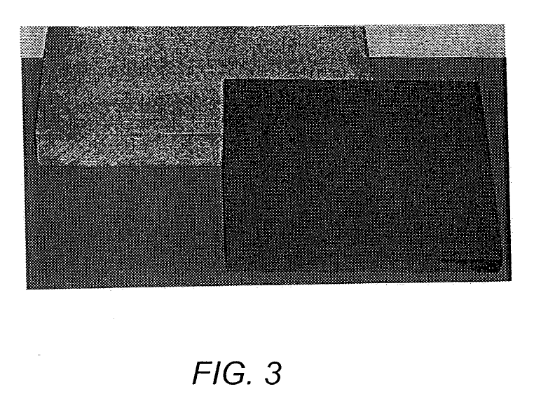

FIG. 3 is a photograph of a carbonized MDF sample next to a non-carbonized piece of MDF material.

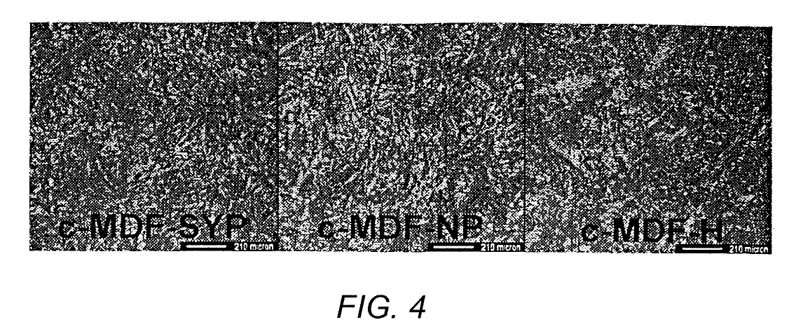

FIG. 4 contains optical micrographs of the three carbonized MDF varieties. As shown, the carbonized wood fibers are preferentially oriented in the plane of the MDF sheet for each variety.

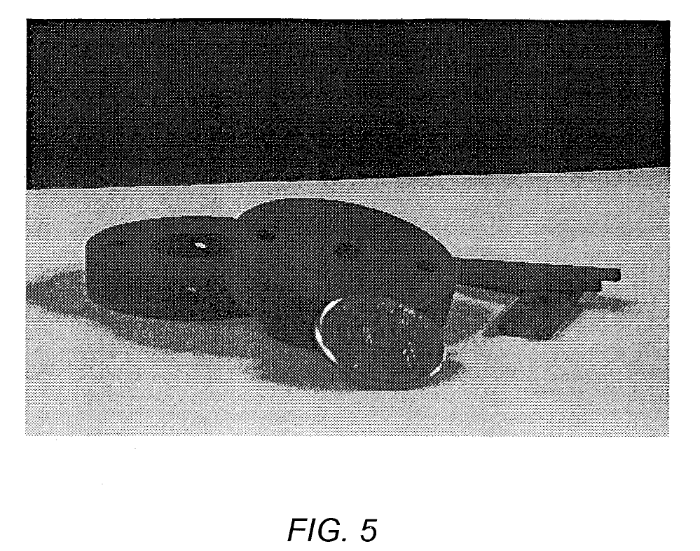

FIG. 5 demonstrates the fine machining of carbonized MDF. The carbonized material was turned on a lathe, drilled, and threaded to achieve the shape of a cross-section from a supersonic nozzle.

Dimensional shrinkage of MDF during carbonization was shown to be nearly uniform in the plane of the MDF sheet, while the dimensional shrinkage of wood during carbonization is highly anisotropic. Because of the uniform structure, MDF is less prone to cracking during carbonization than wood. The typical carbonization time for large pieces of carbonized wood was approximately 4.5 days, but c-MDF was produced in as little as one day without detrimental effect on mechanical or electrical properties. The much more rapid carbonization schedule is presumed to be due to the more isotropic structure and properties of MDF.

In accordance with an embodiment of the present invention, the carbonized fabricated wood-based material may be at least partially converted to activated carbon. Activation may be performed in a carbon dioxide-containing atmosphere, e.g., CO₂ alone or in combination with inert gas, at a temperature of from about 600 to about 1000° C. The activation process may be carried out after the carbonization process, or during carbonization, e.g., during the cooling stage. Alternatively, conventional chemical processing may be used to convert the carbonized material to activated carbon.

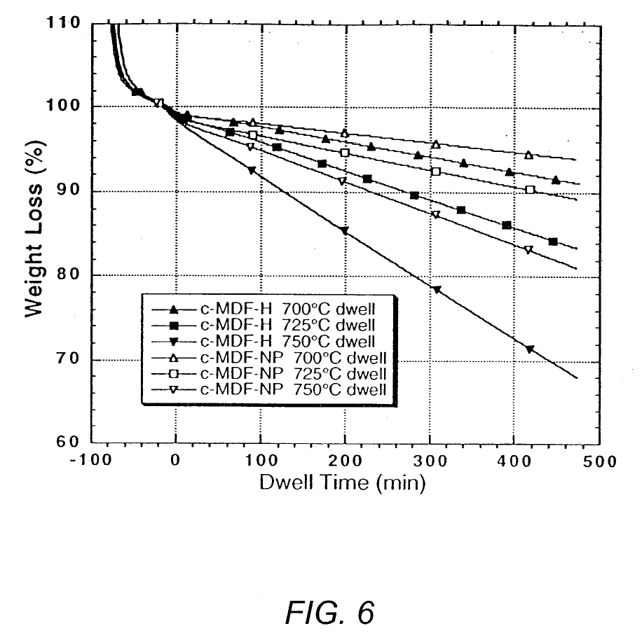

To determine the suitable range of activation temperatures (T_{act}) and activation dwells (d_{act}), small single chunks of c-MDF-H and c-MDF-NP (10-16 mg) underwent thermogravimetric analysis (TGA) in a carbon dioxide atmosphere (using a TA Instruments SDT 2960). FIG. 6 is a graph showing percentage weight loss versus dwell time for the TGA modeling.

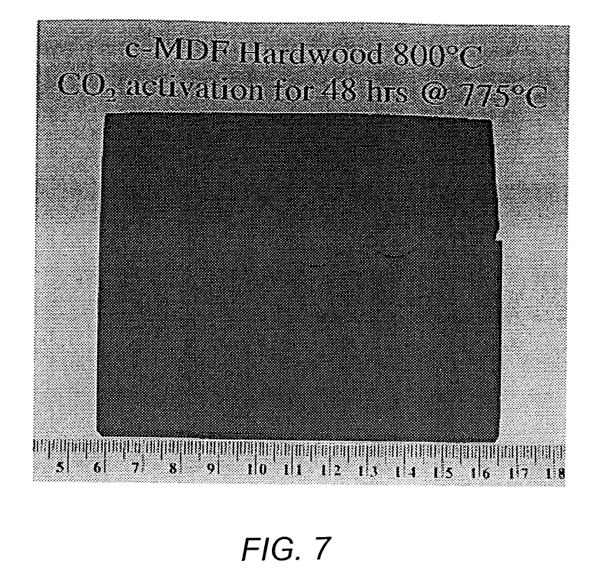

Carbon dioxide activation of small c-MDF specimens was successful in making crack-free monolithic activated carbons for all conditions attempted. Activation of larger pieces was successful under most activation conditions; for large pieces of c-MDF-H activated @775° C. for 16 hours and for 48 hours, a large macrocrack formed during activation, as shown in FIG. 7.

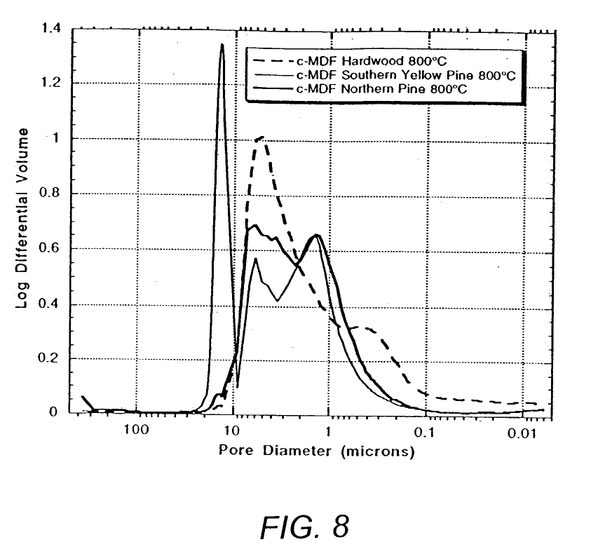

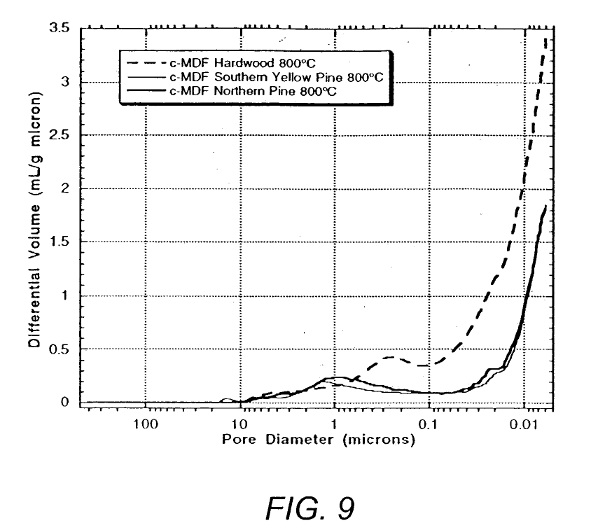

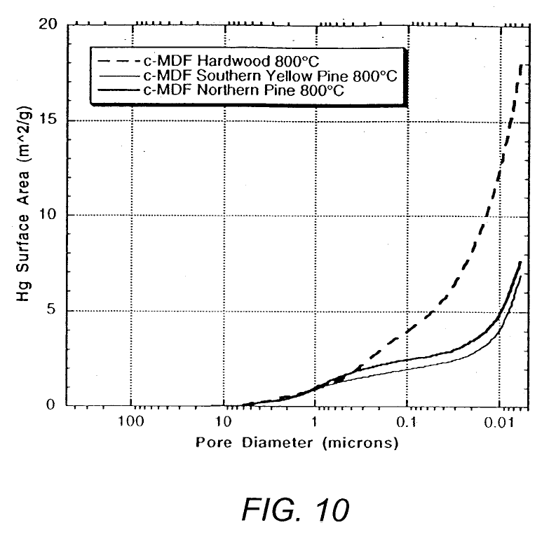

Under a mercury porosimetry test, the log differential volume for each c-MDF carbonized to 800° C. is shown in FIG. 8. The c-MDF-H demonstrated a greater volume of mesopores than the pine c-MDF's, as demonstrated in FIG. 9, which graphs the differential volume of each c-MDF material. The difference in mesopore volume is shown in terms of the cumulative pore surface area of macropores and mesopores of each c-MDF in FIG. 10.

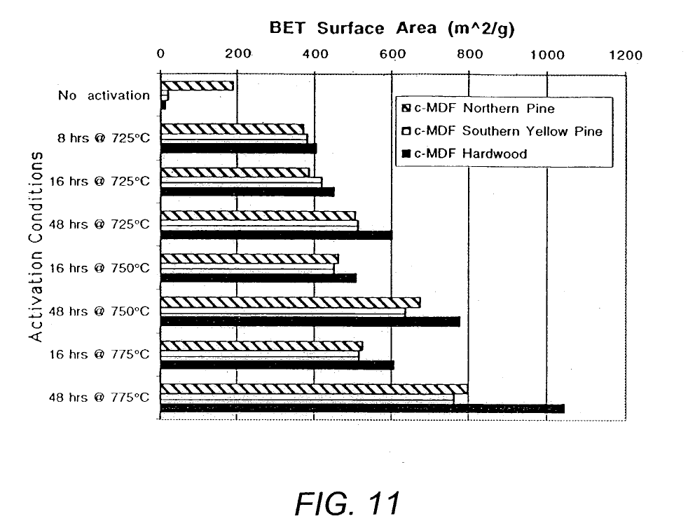

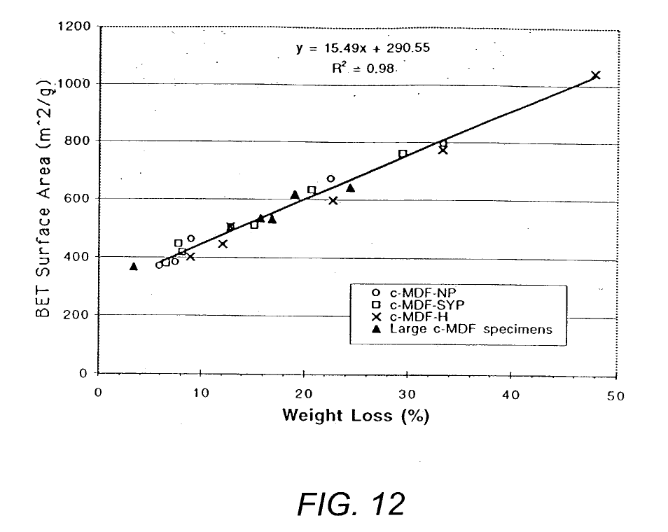

FIG. 11 is a graph of Brunauer-Emmett-Teller (BET) surface area of small c-MDF specimens activated at various conditions. The BET surface area of small c-MDF specimens activated under various conditions was shown to have a strong dependence on c-MDF variety, d_{act}, and T_{act}. The BET surface area as a function of weight loss is presented in FIG. 12.

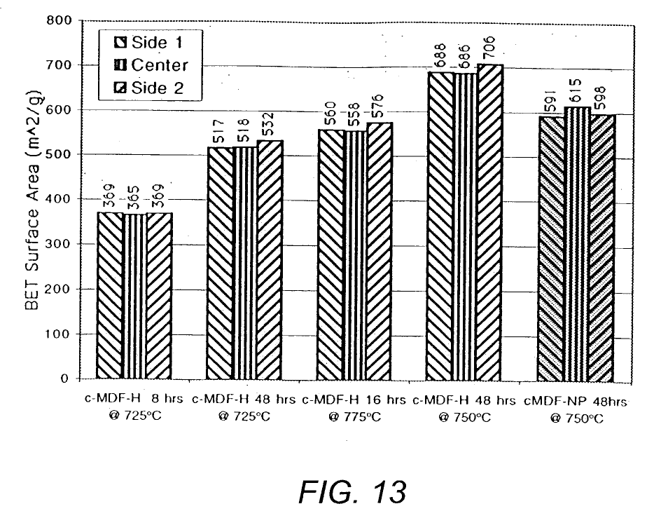

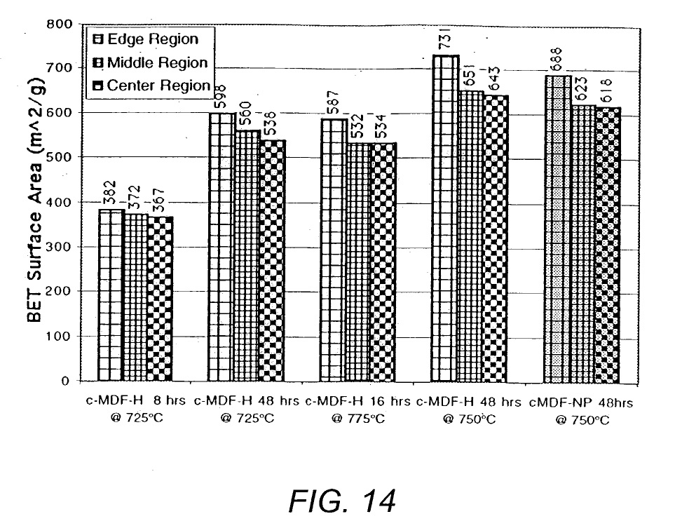

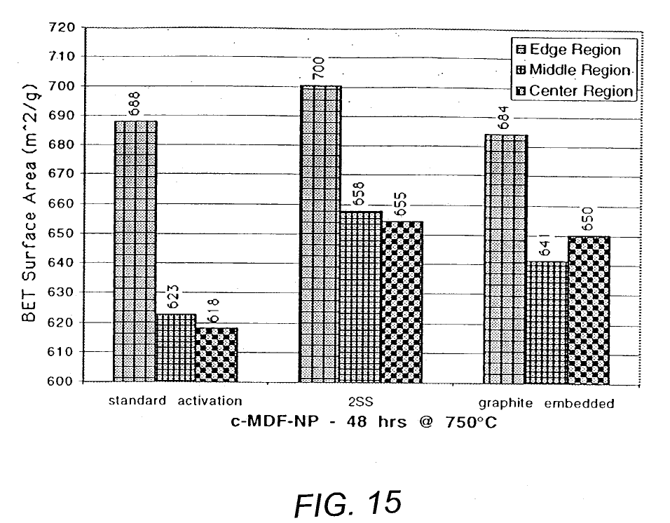

FIG. 13 is a graph of the BET surface area of through-thickness regions of large c-MDF specimens. FIG. 14 is a graph of the BET surface area of in-plane regions of large c-MDF specimens. As shown, the activation of large c-MDF sheets was not perfectly uniform through the thickness or in the plane. The BET surface area non-uniformity showed a consistent trend in-plane for c-MDF-H and c-MDF-NP, but not through-thickness. FIG. 15 is a graph of BET surface area of in-plane regions of large c-MDF-NP specimens activated for 48 hours at 750° C., demonstrating improved in-plane uniformity.

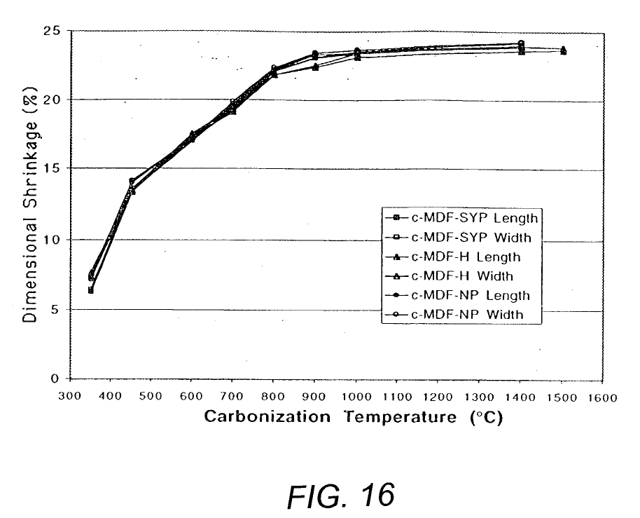

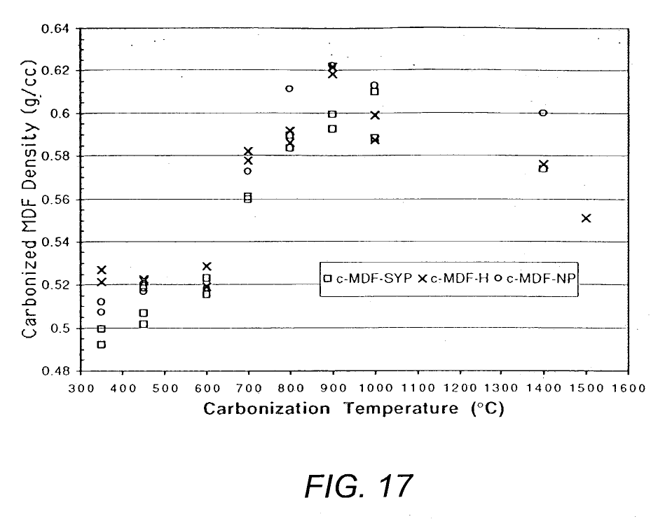

During carbonization, MDF sheets shrank and lost weight. The dimensional shrinkage and yield for the c-MDF's showed the same trend with T_{carb}. FIG. 16 is a graph of the dimensional shrinkage of c-MDF fired to various T_{carb}'s. The bulk density, shown in FIG. 17, increased with T_{carb} up to about 900° C. Above 900° C., the dimensional shrinkage was small and continued weight loss caused a density decrease.

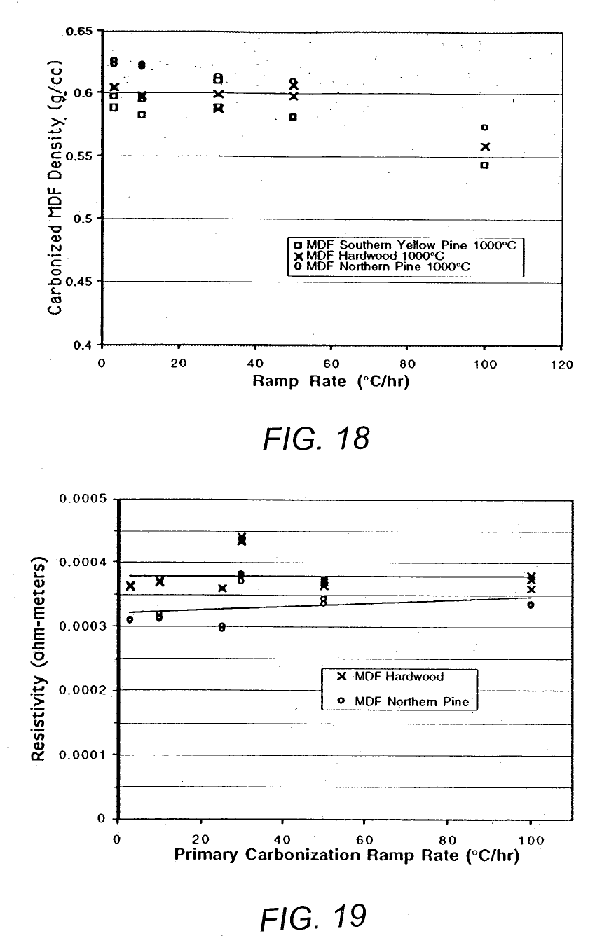

FIG. 18 is a graph of density of the carbonized MDF versus the primary pyrolysis rate. As shown, the density of c-MDF was independent of primary pyrolysis ramp rate up to 50° C./hr, but decreased slightly for the 100° C./hr specimens.

FIG. 19 is a graph of measured resistivity of two varieties of carbonized MDF as a function of primary pyrolysis ramp rate. As shown, the electrical resistivity of c-MDF 1000° C. did not vary significantly for primary pyrolysis ramp rates from 3° C./hr to 100° C./hr.

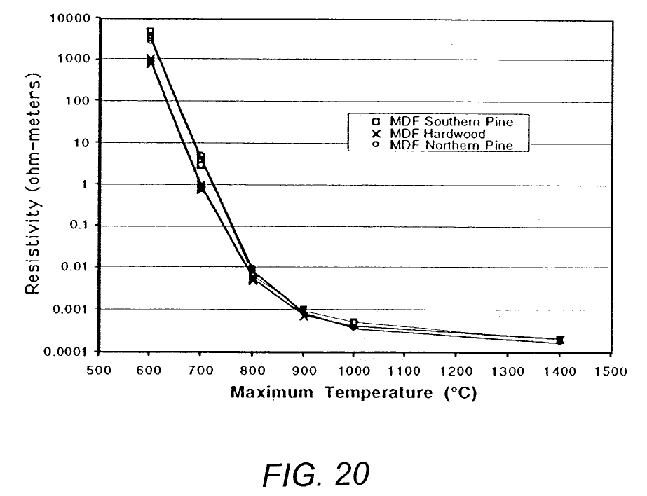

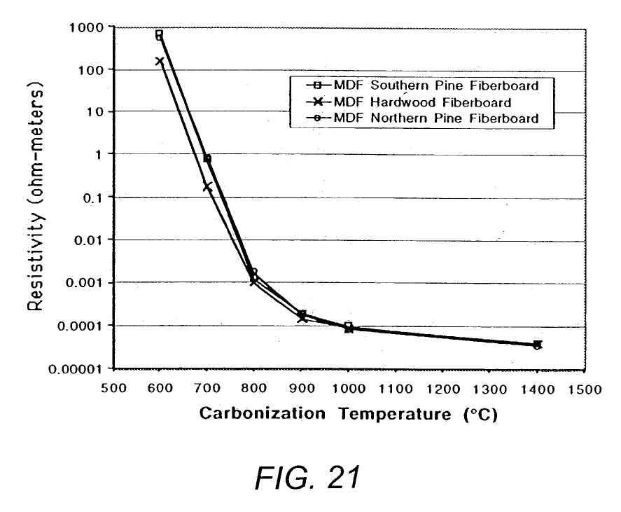

Carbonized wood materials are crosslinked hard carbons, but nonetheless their structures and properties depend strongly on T_{carb}. FIG. 20 depicts measured resistivity as a function of maximum carbonization temperature, while FIG. 21 depicts hard carbon resistivity data derived from the measured c-MDF resistivities. The difference in resistivity decreased with increasing T_{carb}, changing over seven orders of magnitude between 600° C. and 1400° C. (FIG. 20). Each variety of MDF had only slightly different resistivities. Only the MDF hardwood at lower T_{carb} was significantly different.

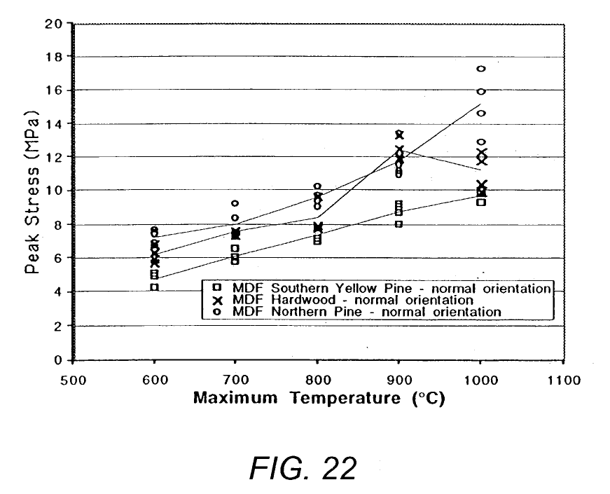

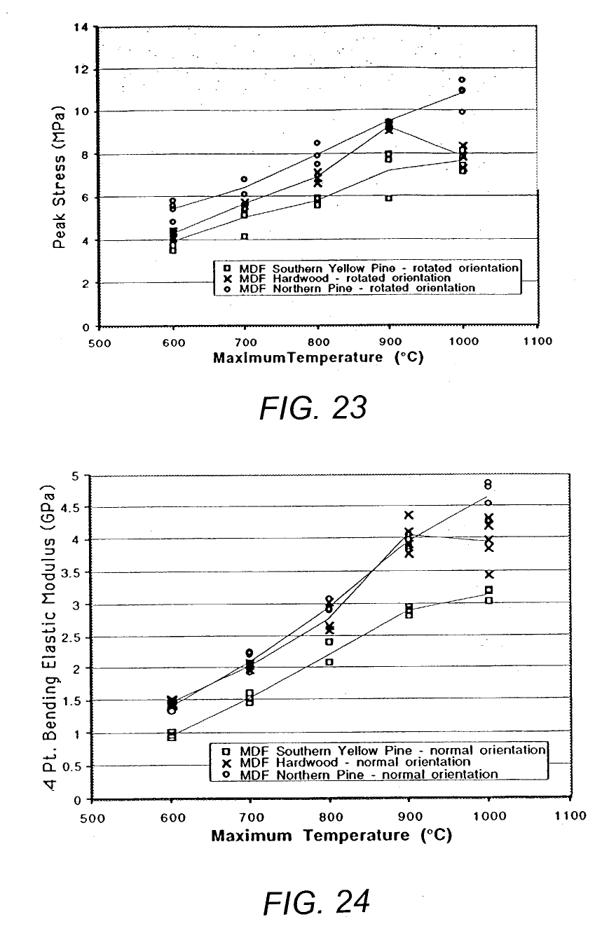

The slow carbonization of MDF resulted in monolithic carbon material with considerable mechanical strength. Peak stress under 4-point bending increased with T_{carb} for both the normal orientation and the rotated orientation, as shown in FIGS. 22 and 23. Under a normal orientation, specimens are oriented with sheet thickness direction along the loading axis. Under a rotated orientation, specimens are oriented with sheet thickness direction perpendicular to the loading axis.

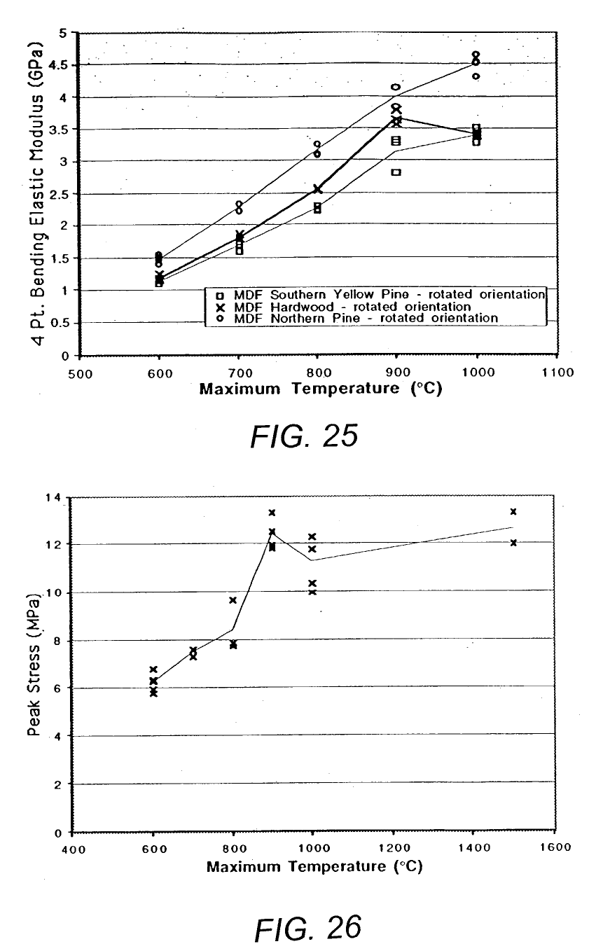

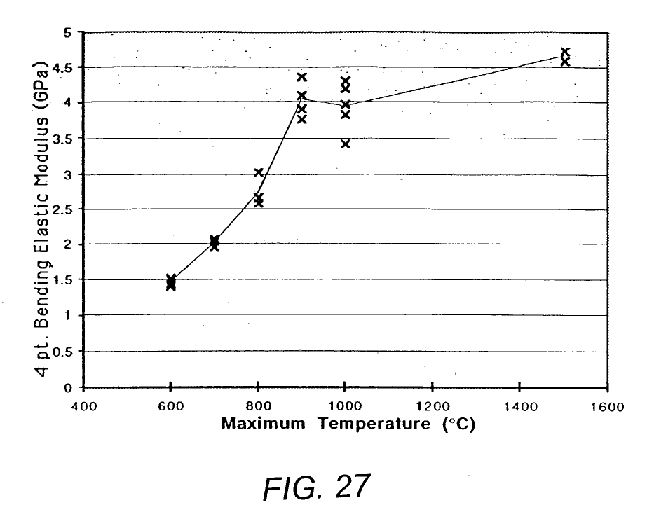

Elastic modulus under 4-point bending also increased with T_{carb} for both orientations, as shown in FIGS. 24 and 25. Carbonized MDF-NP had the highest peak stress and modulus at all T_{carb}, except at 900° C. where the peak stress and stiffness of c-MDF-H were abnormally high. For 1000° C. normal orientation, the average peak stress was ˜16 MPa and the modulus was ˜4.5 GPa. Carbonized MDF-SYP consistently had the lowest peak stress and modulus. Specimens of MDF Hardwood were heated up to 1500° C. to determine the effect of high temperature carbonization on mechanical properties. Samples from high T_{carb} are included in FIGS. 26 and 27.

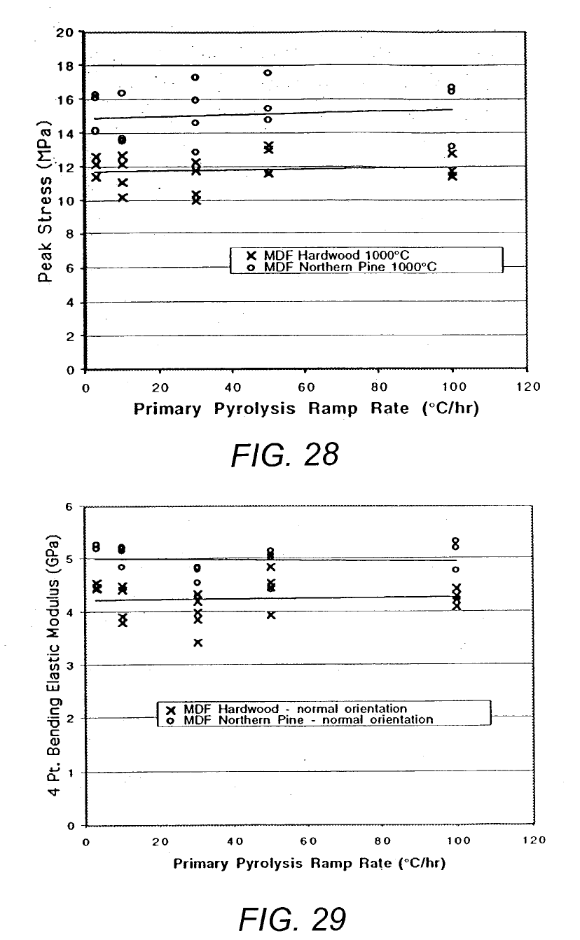

The density of c-MDF (FIG. 18) was independent of primary pyrolysis ramp rate up to 50° C./hr, but decreased slightly for the 100° C./hr specimens. The electrical resistivity of c-MDF 1000° C. did not vary significantly for primary pyrolysis ramp rates from 3° C./hr to 100° C./hr (FIG. 19). The peak stress and elastic modulus (normal orientation) showed little or no dependence on primary pyrolysis ramp rate (FIGS. 28 and 29). At all primary pyrolysis ramp rates studied, c-MDF-H exhibited a higher resistivity, a lower elastic modulus, and a lower peak stress than c-MDF-NP.

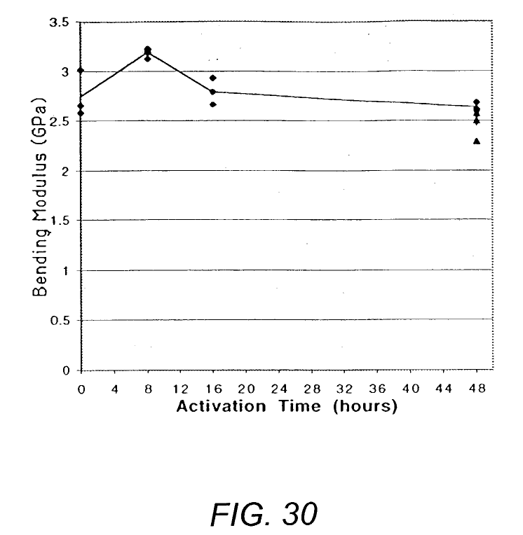

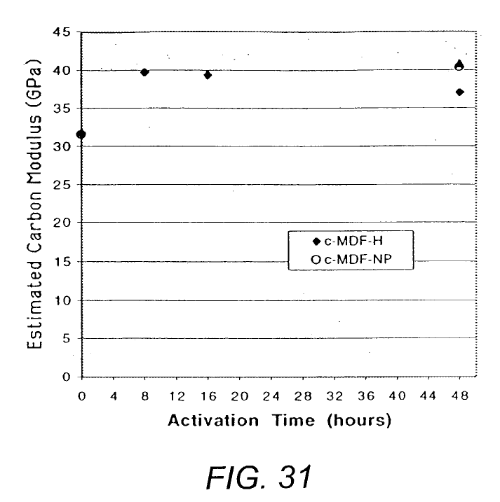

Activation affected the stiffness and strength of c-MDF-H bending modulus (equivalent to Young's modulus if assumed isotropic). FIG. 30 is a graph of bending modulus versus activation time, showing a slight increase in bending modulus for one sample, but for all other samples, approximately the same bending modulus as the unactivated material. FIG. 31 is a graph of the estimated Young's modulus of hard carbon phase in c-MDF materials.

Detailed x-ray diffraction (XRD) of c-MDF powders was used to gain insight into the microstructural evolution of the c-MDF structure during the carbonization process. Using Scherrer equations derived by Warren, x-ray diffraction of c-MDF powder was used to track the growth of graphene sheets and turbostratic crystallites. During carbonization from 450° C. to 1400° C., the average diameter of large graphene sheets (Lₐ) in c-MDF-H and c-MDF-NP grew from about 45 angstroms to 88 angstroms. For carbonization temperatures (T_{carb}'s) from 600° C. to 1000° C., the large turbostratic crystallites had an average thickness of just over 6 graphene sheets.

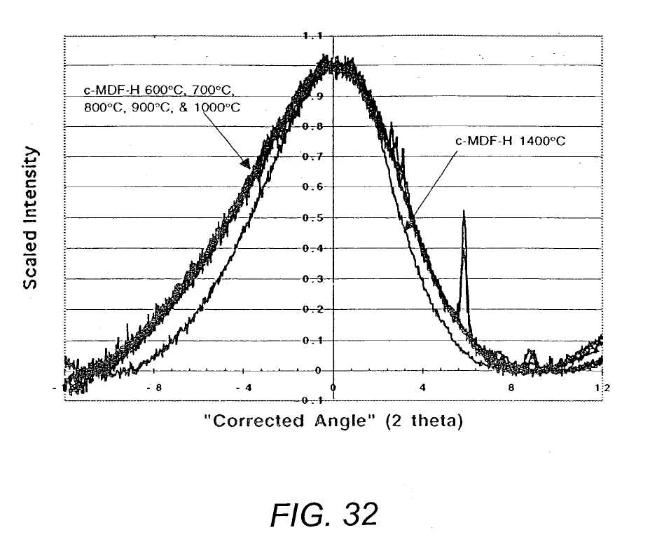

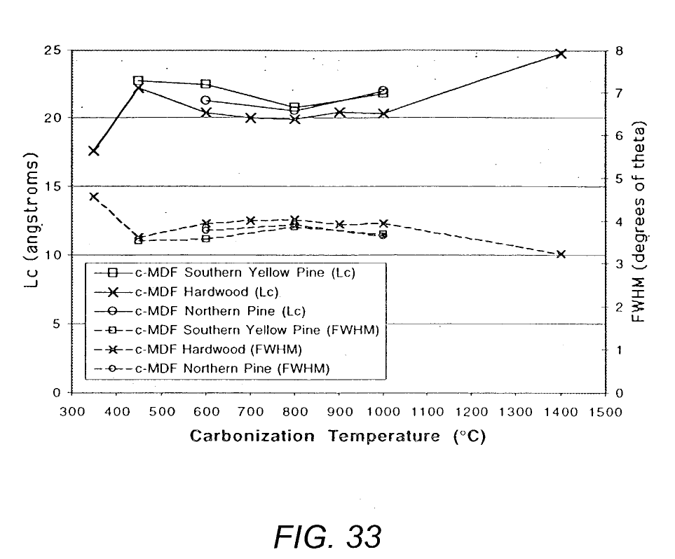

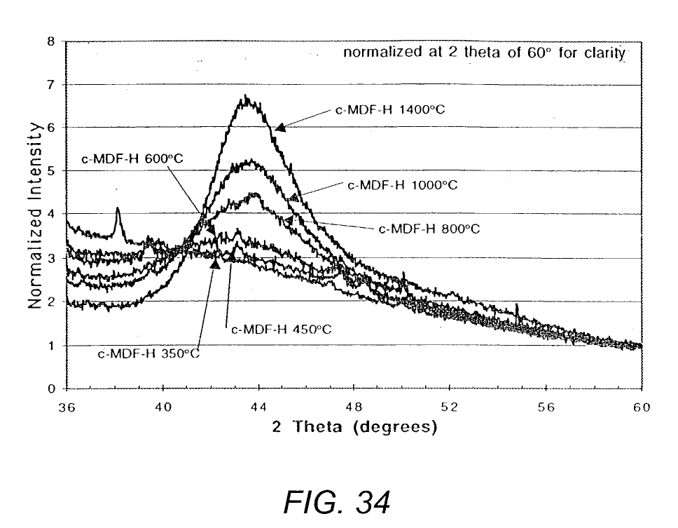

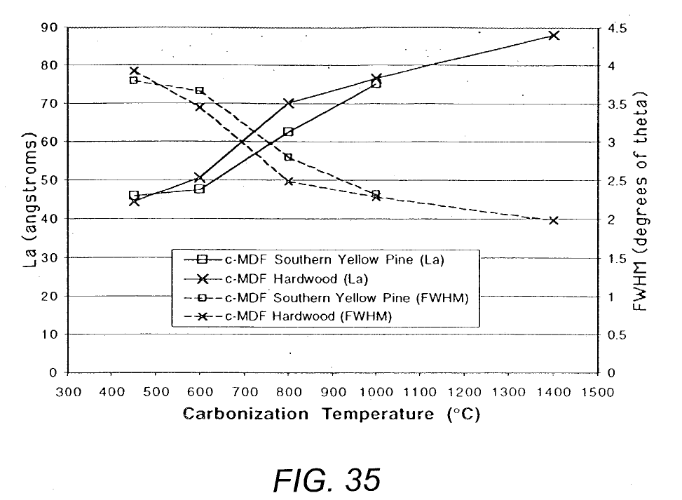

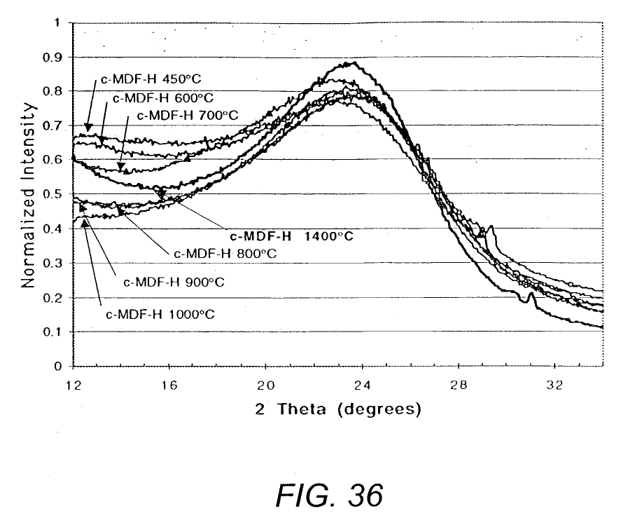

FIG. 32 is a graph demonstrating the significant full-width half-maximum (FWHM) difference between c-MDF-H 1400° C. and other c-MDFH's. The {002} powder XRD peaks from c-MDF-H materials (linear-subtracted patterns) were centered on the y-axis and were sealed to the same maximum intensity for comparison. FIG. 33 illustrates FWHM data of the {002} powder XRD peaks and the associated average L_{c}'s for various c-MDF-H's. FIG. 34 shows powder XRD patterns of {100} peak, normalized at 2θ=60° for asthetic reasons. FIG. 35 illustrates FWHM data of the {100} powder XRD peaks and the associated average Lₐ's for various c-MDF-H's. FIG. 36 depicts raw monolithic XRD patterns with the only correction being from x-ray beam intensity calibration.

The powder XRD analysis of c-MDF-H materials showed a T_{carb} range (600-1000° C.) of nearly constant full-width half-maximum (FWHM) for the {002} peak, but the {002} peak intensity varied over the same T_{carb} range. There are three common mechanisms for {002} peak intensity change: (1) an L_{c} growth effect, (2) a strain distribution effect, and (3) a change in the amount of carbon detected in large turbostratic crystallites. Only the last mechanism does not have a corresponding change in the FWHM. Therefore in the T_{carb} range of 600° C. to 1000° C., the {002} peak intensity of c-MDF-H could be correlated to the amount of carbon detected in large turbostratic carbon crystallites.

X-ray diffraction analysis of monolithic c-MDF-H samples from c-MDF-H sheets was used to compare the relative amount of carbon contained in large turbostratic crystallites for c-MDF-H of various temperatures. Because monolithic samples were used, the bulk dimensional changes of the c-MDF-H as a function of T_{carb} could be correlated to XRD results. As the carbonization temperature increased, the volumetric shrinkage during carbonization would cause turbostratic crystallites to come closer together. Volumetric shrinkage of c-MDF-H could account for only a portion of the observed increase in the {002} peak intensity with the carbonization temperature. The other cause for the observed intensity increase was an 8.5% growth of the large turbostratic crystallites in the Lₐ direction from 600° C. to 1000° C.

The rapid growth of large graphene sheets during carbonization, shown by powder x-ray diffraction, sharply contrasts the slow growth of the large turbostratic crystallites, shown by x-ray diffraction of monolithic samples. This discovery led to the development of a new model describing the microstructural evolution occurring during carbonization of MDF and other hard carbon precursors. Because the model was conceptually similar to classical percolation models, we refer to this new theory as the “quasipercolation” model. The quasipercolation model is qualitatively similar to a bond percolation model where volumetric shrinkage brings the turbostratic crystallite sites closer together. Nucleation and growth of turbostratic crystallites is only significant at low temperatures (below 450° C.). Above 450° C., the disordered carbon phase converted into aromatic carbon that is incorporated into large graphene sheets. These large graphene sheets are the same graphene sheets that make up the turbostratic crystallites, but all the graphene sheets of a crystallite do not grow uniformly. In a turbostratic crystallite, nanoporosity forms in the gaps between graphene sheets that grow and graphene sheets that don't grow. Volumetric contraction is associated with the phase change from the disordered carbon to the graphene sheet material. The volumetric contraction of the phase change causes significant bulk volumetric contraction until the large graphene sheets of different crystallites significantly impinge on each other at around 900° C. At impingement regions, the continued volumetric contraction of the phase change causes the formation of large micropores/microcracks.

The quasipercolation model agreed with physical property changes of c-MDF's and other hard carbons as a function of carbonization temperature. Bulk density, dimensional changes, and helium density of c-MDF agreed with the trend expected based on the quasipercolation model. The nonmetal-metal transition can be explained by the increased impingement of conductive phases. The quasipercolation model explained how nanoporosity forms in activated carbons.

The electrical resistivity and mechanical properties in 4-point bending of c-MDF boards were measured to identify potential electrical applications for these machineable monolithic materials, such as fuel cell gas separators and battery electrodes. With applied loads perpendicular to the c-MDF sheet plane, the elastic bending modulus of c-MDF-NP in 4-point bending increased from 1.5 GPa to 4.5 GPa for T_{carb} of 600° C. to 1000° C. With the load applied in the plane of the c-MDF sheet, the elastic bending modulus of c-MDF was nearly equal to the elastic bending modulus for the other orientation. Thus, the elastic modulus of c-MDF was nearly isotropic, despite the strong preferential orientation of the carbonized wood fibers in the c-MDF sheet plane. With the load applied perpendicular to the MDF sheet plane, the peak tensile stress of c-MDF-NP increased from 5.5 MPa to 11 MPa for T_{carb} from 600° C. to 1000° C. With the load applied in the MDF sheet plane, the peak tensile stress was significantly less than for the other orientation, but scratches created while machining the mechanical specimens likely caused the lower peak stress. Similar to other hard carbons, the electrical resistivity of c-MDF showed a nonmetal-metal transition as a function of T_{carb}. For T_{carb} from 600° C. to 1400° C., the electrical resistivity of c-MDF varied by over seven orders of magnitude.

To estimate the physical properties of the hard carbon phase in the porous c-MDF materials, c-MDF was modeled as an open foam. Traditional expressions relating solid phase properties to bulk foam properties were used to determine the electrical resistivity and elastic modulus of hard carbon in c-MDF from measured bulk c-MDF properties. Based on this model, the electrical resistivity of the hard carbon of c-MDF 1400° C. was as low as 3.6×10⁻⁵ Ωm, which is within an order of magnitude of the resistivity of polycrystalline graphite. The elastic modulus of hard carbon based on this model exceeded the modulus of typical polycrystalline graphite (˜27 GPa) by almost a factor of two.

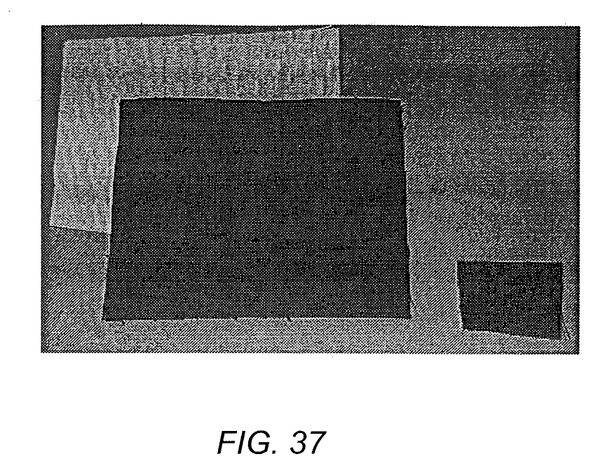

Physical activation of c-MDF with carbon dioxide was used to generate monolithic activated carbons. Activated carbon cloths, shown in FIG. 37, are currently the only commercially available monolithic activated carbons. This study demonstrated the feasibility of making large structural activated carbons from MDF materials. Physical activation was achieved by heating c-MDF 800° C. materials up to 725-775° C. in a carbon dioxide atmosphere. Physical activation of small c-MDF-H specimens (approx. 4 cm×11 cm) resulted in BET surface areas as high as 1044 m²/g (activated 48 hrs. at 775° C.). Large c-MDF specimens (approx. 9.5 cm×11 cm) demonstrated macrocracks during activation at 775° C. Macrocracks may have been caused by stress release during the activation process that could be prevented by a longer dwell time during carbonization. Large c-MDF specimens were activated to as much as 650 m²/g (activated 48 hrs. at 750° C.). In-plane and through-thickness variations in BET surface area were measured for the large c-MDF specimens. The variations in surface area through the thickness of the c-MDF sheets were only as high as 20 m²/g. The variations in surface area in the plane of the c-MDF sheets were as high as 70 m²/g. Minor alternations of the activation method showed some success in decreasing the in-plane variations in surface area. To determine the effects of activation on the structural strength of c-MDF, 4-point bending specimens were machined from the large activated c-MDF pieces. The activated c-MDF's with high surface area showed significantly lower peak stress (6.2 MPa for an activated c-MDF compared to 8.4 MPa for unactivated c-MDF), but only a slightly decreased elastic modulus.

### EXAMPLE 2

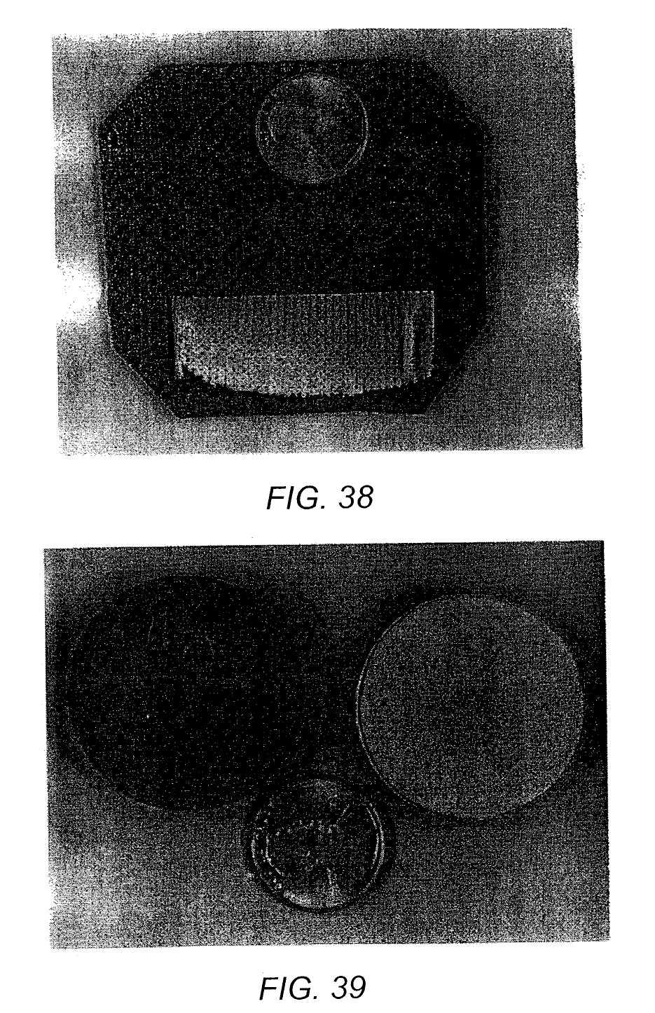

Several natural fiber fabrics were carbonized under controlled conditions to produce non-graphitic carbon fabrics. Cotton, muslin, linen, aida and rayon, with no coloring dyes, were all carbonized. In one experiment, carbonized specimens were soaked in a colloidal suspension of alumina (Nyacol AL-20). A vacuum assist was used to assure infiltration. The specimens were allowed to dry thoroughly for days. Then heat treatment in a nitrogen atmosphere to 1500° C. was performed. The specimens were white to gray-white, and intact. XRD analysis detected aluminum nitride (AlN) and some residual alumina (Al₂O₃). FIG. 38 is a photograph of converted aida cloth comprising aluminum nitride.(light) overlying a piece of carbonized aida of coarser weave (dark). The solid carbon fabric acts as a carbon source for reduction of the oxide. When performed in a nitrogen atmosphere above 1400° C. the metal is less stable than the nitride. A similar example was performed by soaking the cellulosic cloths in the sol-gel, then carbonizing and converting in one process. Similar results were obtained.

Other examples using carbonized fabrics and silica sol-gel give results similar to those obtained using monolithic wood. Conversion products detected by XRD analysis are SiC and cristobalite. Other ceramics and carbides from carbonized fabrics and papers may also be produced in accordance with the present invention.

### EXAMPLE 3

Monolithic AlN ceramics were made using pressed wood sawdust as a precursor. A mixture of phenolic resin powder (Varcum 29217), mixed species wood sawdust and alumina powder was pressed into pellets. A series of tests indicated that 20 wt % phenolic provided adequate bonding of the mixture. The ratio of alumina to sawdust/phenolic mix was varied from a carbon-rich ratio, to a stoichiometric ratio, based on expected solid carbon yield of the organics and a one to one (C+O→CO) reduction ratio. Pellets were cured in a hot press at 180° C. for 4 minutes. Carbonization to 600° C. in a nitrogen atmosphere produced pellets which retained their shape. Further heat treatment for 4 hrs at 1550° C. in a nitrogen atmosphere was performed. The resulting pellets ranged in color from gray to white. The degree of whiteness decreased with increasing carbon to alumina ratio of precursor mix. A photograph of carbonized and converted pellets is shown in FIG. 39, with the carbonized sample on the left side and the AIN sample on the right side of the photograph. XRD scans of the converted pellets detected AlN. No residual alumina was found. Weak peaks at 26° 2-theta was detected in some of the specimens indicating the presence of some residual solid carbon. TGA experiments of the mix detected the weight loss associated with the oxide reduction at temperatures above 1400° C. No differential temperature was detected from the reaction. Furthermore, mixtures of sawdust, phenolic and Si may be converted to SiC. Carbon-carbon and carbon-polymer composites can also be produced by this processing method.

The present invention provides a process for the manufacture of porous carbons, composites and ceramics using fabricated wood-based material. The process has the potential for producing industrially important materials at a reduced cost due to its simplicity, and the fact that it makes use of a renewable resource.

While various aspects of the invention have been discussed above, it is to be understood that various modifications, adaptations and changes may be made without departing from the scope of the invention as set forth in the following claims.

What is claimed is:

1. A method of making a carbon-containing article, the method comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; and
recovering the carbonized material.

2. The method of claim 1, wherein the fabricated wood-based material comprises particleboard, fiberboard and/or plywood.

3. The method of claim 1, wherein the fabricated wood-based material comprises a fabric.

4. The method of claim 1, wherein the fabricated wood-based material has a length of greater than about 1 inch.

5. The method of claim 4, where the fabricated wood-based material has a width of at least about 0.5 inch.

6. The method of claim 5, wherein the fabricated wood-based material has a height of at least about 0.1 inch.

7. The method of claim 1, further comprising cutting the fabricated wood-based material to shape prior to heating.

8. The method of claim 1, further comprising machining the fabricated wood-based material to shape prior to heating.

9. The method of claim 1, further comprising pressing the fabricated wood-based material to shape prior to heating.

10. The method of claim 1, wherein the fabricated wood-based material is heated in an inert atmosphere.

11. The method of claim 10, wherein the inert atmosphere comprises nitrogen.

12. The method of claim 1, wherein the fabricated wood-based material is heated at substantially atmospheric pressure.

13. The method of claim 1, wherein the fabricated wood-based material is heated to a temperature of at least about 300° C.

14. The method of claim 13, wherein the fabricated wood-based material is heated to a temperature of less than about 1500° C.

15. The method of claim 1, wherein the fabricated wood-based material is heated to a temperature of from about 400 to about 1000° C.

16. The method of claim 1, wherein the fabricated wood-based material is heated at a heat-up rate of less than about 100° C./hour.

17. The method of claim 16, wherein the heat-up rate is from about 1 to about 50° C./hour.

18. The method of claim 1, wherein the fabricated wood-based material is heated at a rate of less than about 20° C./hour during at least a portion of the heating.

19. The method of claim 1, wherein the carbonized material comprises graphite.

20. The method of claim 19, wherein the carbonized material is converted to graphite by heating to a temperature of at least about 2000° C.

21. The method of claim 1, further comprising shaping the carbonized material.

22. The method of claim 21, wherein the carbonized material is shaped by cutting.

23. The method of claim 22, wherein the cutting comprises a process selected from the group consisting of sawing, drilling, routing, milling, turning, grinding and sanding.

24. The method of claim 1, further comprising converting at least a portion of the carbonized material to activated carbon.

25. The method of claim 24, wherein the conversion to activated carbon is performed in a carbon dioxide-containing atmosphere at a temperature of from about 600 to about 1000° C.

26. The method of claim 1, further comprising at least partially filling pores of the carbonized material with a metal.

27. The method of claim 1, further comprising at least partially filling pores of the carbonized material with a polymer.

28. The method of claim 27, further comprising at least partially converting the polymer to carbon.

29. The method of claim 28, wherein the polymer comprises a phenolic resin.

30. The method of claim 1, further comprising at least partially converting the carbonized wood to a ceramic.

31. The method of claim 30, wherein the ceramic comprises silicon carbide.

32. The method of claim 30, further comprising at least partially filling pores of the ceramic with a metal.

33. The method of claim 30, further comprising at least partially filling pores of the ceramic with a ceramic.

34. A carbonized article consisting essentially of carbon having a porous cellular structure corresponding to the cellular structure of fabricated wood-based material.

35. The article of claim 34, wherein the fabricated wood-based material comprises particleboard, fiberboard and/or plywood.

36. The article of claim 34, wherein the carbonized article has at least one dimension greater than about 1 inch.

37. The article of claim 34, wherein the carbonized article is cut to shape.

38. A method of making a carbon-polymer composite comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material;
cooling the carbonized material; and
at least partially filling pores of the carbonized material with a polymer.

39. The method of claim 38, wherein the pores are at least partially filled with the polymer by infiltrating the pores with a polymeric fluid and curing the fluid.

40. The method of claim 38, wherein the polymer is selected from the group consisting of epoxies, phenolics and pitch.

41. A method of making a carbon-metal composite comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material; and
at least partially filling pores of the carbonized material with metal.

42. A method of making a carbon-carbon composite comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material;
cooling the carbonized material;
at least partially infiltrating pores of the carbonized material with a carbon-forming material; and
converting at least part of the carbon-forming material to carbon.

43. The method of claim 42, wherein the carbon-forming material comprises a phenolic resin which is at least partially converted to carbon by heating.

44. A method of forming a ceramic-containing material comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material;
cooling the carbonized material; and
converting at least part of the carbonized material to a ceramic.

45. The method of claim 44, wherein at least part of the carbonized material is converted to silicon carbide by reacting the carbon with silicon.

46. A method of forming a ceramic-containing material comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material;
cooling the carbonized material; and
converting at least part of the carbonized material to a ceramic.

47. A method of making a ceramic-ceramic composite comprising:
providing a fabricated wood-based material comprising a cellular structure;
heating the fabricated wood-based material in a substantially non-oxidizing atmosphere to a sufficient temperature at a sufficiently slow heat-up rate to carbonize the fabricated wood-based material while substantially maintaining the cellular structure of the fabricated wood-based material;
cooling the carbonized material;
converting at least part of the carbonized material to a first ceramic; and
at least partially filling pores of the ceramic with a second ceramic.

48. The method of claim 47, wherein the first ceramic is of different composition from the second ceramic.

49. A carbon-polymer composite article comprising:
a carbonized fabricated wood-based material comprising a porous cellular structure; and
a polymer at least partially filling the pores of the carbonized fabricated wood-based material.

50. A carbon-carbon composite article comprising:
a carbonized fabricated wood-based material comprising a porous cellular structure; and
carbon at least partially filling the pores of the carbonized fabricated wood-based material.

51. A carbon-metal composite article comprising:
a carbonized fabricated wood-based material comprising a porous cellular structure; and
a metal at least partially filling the pores of the carbonized fabricated wood-based material.

52. A porous ceramic-containing material comprising ceramic having a porous cellular structure corresponding to a cellular structure of fabricated wood-based material.

53. A ceramic-metal composite article comprising:
a ceramic having a porous cellular structure corresponding to the cellular structure of fabricated wood-based material; and
metal at least partially filling the pores of the ceramic.

54. A ceramic-ceramic composite article comprising:
a first ceramic having a porous cellular structure corresponding to the cellular structure of fabricated wood-based material; and
a second ceramic at least partially filling the pores of the first ceramic.
